(19) United States
(12) Patent Application Publication
(10) Pub. No.: US 2015/0159754 A1
(43) Pub. Date: Jun. 11, 2015

(54) EXPANDABLE BAFFLE/SEAL WITH PATTERN OF PROJECTIONS AND VOIDS

(71) Applicant: SIKA TECHNOLOGY AG, Baar (CH)

(72) Inventors: Brent Logan, Grandview, MO (US); Chris Leyda, Grandview, MO (US)

(73) Assignee: SIKA TECHNOLOGY AG, Baar (CH)

(21) Appl. No.: 14/098,175

(22) Filed: Dec. 5, 2013

(51) Int. Cl. F16J 15/02

(52) U.S. Cl. CPC F16J 15/028; F16J 15/022

(57) ABSTRACT

A generally planar baffle is disclosed. The baffle has an expandable layer coupled to an adhesive layer. The expandable layer has on its external surface a pattern of projections and a pattern of voids relative to the projections, such that the projections define a first thickness of the expandable layer and the voids define a second thickness of the expandable layer, wherein the first thickness is greater than the second thickness.

### BACKGROUND

Manufactured products commonly have various orifices and cavities that result from the manufacturing process and/or that are designed into the product for various purposes, such as weight reduction. Motor vehicles, for example, include several such orifices and cavities throughout the vehicle, including in the vehicle's structural pillars and in the sheet metal of the vehicle doors. It is often necessary to seal such orifices and cavities so as to control noise, fumes, dirt, water and the like from passing from one area to another within the vehicle.

Various baffles and seals have been used to seal orifices and cavities in manufactured products, such as motor vehicles. One known baffle used for such purposes is illustrated in FIGS. 1 and 2. The baffle 10 is a generally-planar two-layer baffle, including an expandable layer 12 and an adhesive layer 14. The baffle 10 is commonly manufactured using an extrusion process. The outer surfaces of the expandable layer 12 and the adhesive layer 14 are substantially smooth. The expandable layer 12 is comprised of material that expands upon being activated, typically by the application of elevated heat for a particular duration of time. For example, expandable materials used on baffles found in automotive vehicles are generally formulated to expand in response to the amount of heat and duration of time found in typical e-coat ovens used by automotive vehicle manufacturers. Upon activation (by application of heat or otherwise), the expandable material expands to fill and seal the orifice or cavity.

The thickness of the pre-activated expandable material 12 may vary depending on the particular application. As the thickness of the expandable material increases, though, the performance of the baffle 10 may decrease because the interior portion of the expandable material is not exposed to the same temperature level for the same amount of time as the outer portions of the expandable material. In effect, the expandable material “self-insulates,” such that the inner portions of the expandable material may not expand as fully or as quickly as the outer portions of the expandable material. The inventors hereof have developed a new baffle with improved performance characteristics.

### SUMMARY

A generally planar baffle is disclosed. The baffle has an expandable layer coupled to an adhesive layer. The expandable layer has on its external surface a pattern of projections and a pattern of voids relative to the projections, such that the projections define a first thickness of the expandable layer and the voids define a second thickness of the expandable layer, wherein the first thickness is greater than the second thickness. The shape and configuration of the projections and voids may take different forms. In certain embodiments, the pattern of projections is a plurality of ridges and the pattern of voids is a plurality of voids relative to the ridges.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates a perspective view of known baffle.

FIG. 2 illustrates a side view of the known baffle illustrated in FIG. 1.

FIG. 3 illustrates a perspective view of an improved baffle according to a first embodiment.

FIG. 4 illustrates a side view of the improved baffle illustrated in FIG. 3.

FIG. 5 illustrates a perspective view of a second embodiment of an improved baffle.

FIG. 6 illustrates a perspective view of a third embodiment of an improved baffle.

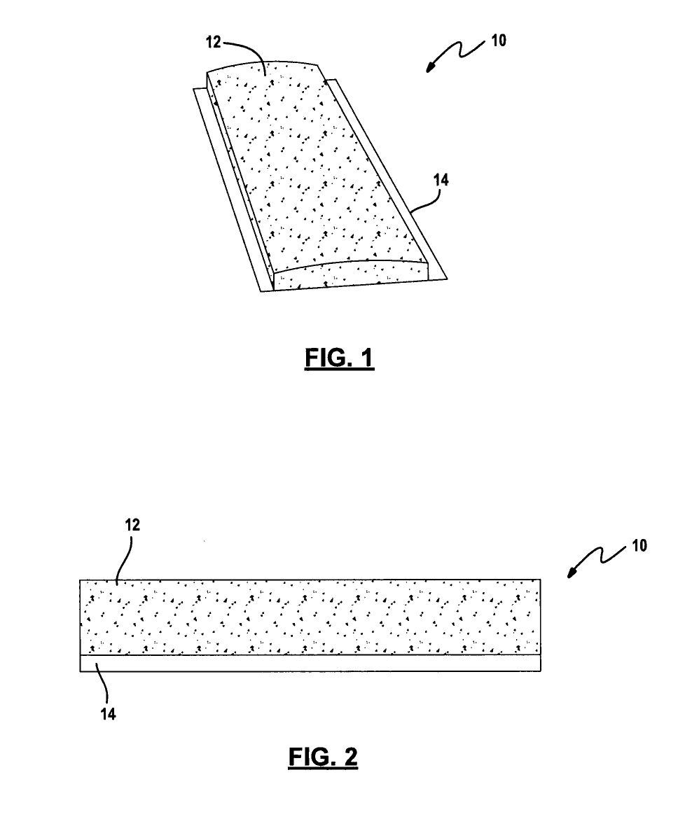

Corresponding reference numerals indicate corresponding parts throughout the several views of the drawings.

### DETAILED DESCRIPTION

Disclosed herein is an improved baffle, which demonstrates better performance and uses less material than known baffles used for similar applications. The improved baffle includes two layers, an expandable layer and an adhesive layer. The expandable layer includes on its outer surface a pattern of projections, such as ridges, and a pattern of voids relative to the projections, such as grooves or channels. The voids, e.g., grooves or channels, allow the applied heat to better penetrate into the interior portion of the expandable layer, which improves the expansion of the interior portion of the expandable layer. Additionally, the voids in the expandable layer reduce the amount of expandable material required in the baffle, which improves the cost-effectiveness of the product.

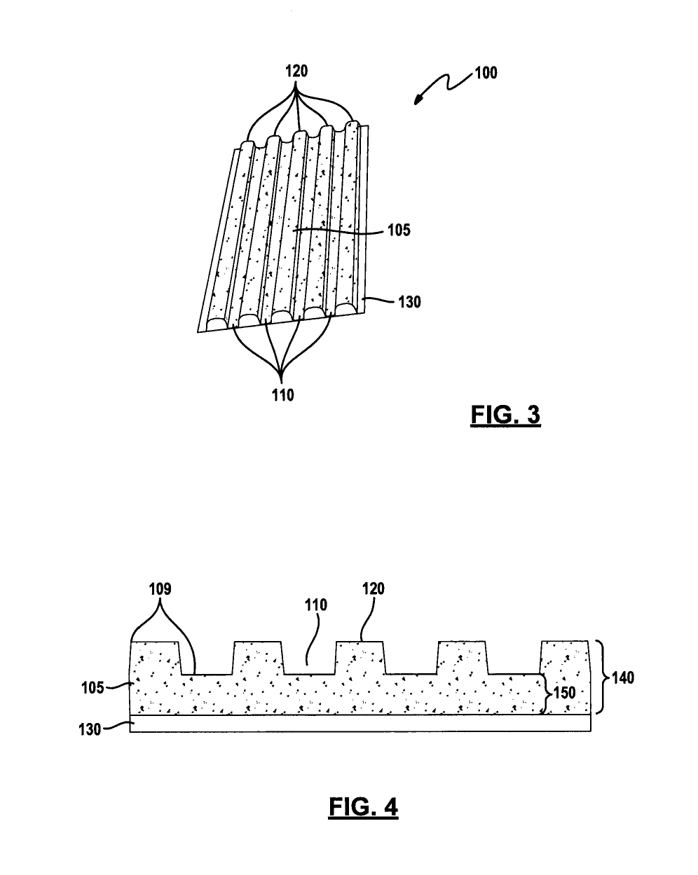

FIGS. 3 and 4 illustrate one embodiment of the improved baffle. FIG. 3 is a perspective view of the improved baffle 100, which includes an expandable layer 105 and an adhesive layer 130. The adhesive layer 130 is used to secure the baffle 100 in place in the manufactured product during the manufacturing process and prior to being activated and expanded. The expandable layer 105 is configured to expand in response to being activated, such as by application of a particular elevated temperature for a particular duration, and thereby seal an orifice or cavity. The orifice or cavity is typically defined by sheet metal or other panels, such as those found in automotive vehicles.

The expandable layer has an interior portion 107 and an external surface 109. The external surface 109 comprises multiple levels formed from a combination of voids and projections of the expandable layer 105. The voids are illustrated in FIGS. 3 and 4 as grooves or channels 110. The projections are illustrated in FIGS. 3 and 4 as ridges 120, which alternate with and complement the grooves/channels 110. As a result of the void/projection configuration—illustrated in FIGS. 3 and 4 as grooves/channels 110 and ridges 120—the expandable layer 105 has a primary thickness 140 defined by the thickness of ridges 120, and the expandable layer 105 has a secondary thickness 150 defined by the thickness of the expandable layer 105 at the locations of the grooves/channels 110. The primary thickness 150 is determined for the intended application, and, for example, may be 5 mm or 3.3 mm in certain applications. In one embodiment, the secondary thickness 150 is approximately one half of the primary thickness 140. The expandable layer 105 and the adhesive layer 130 may be manufactured by extruding.

The expandable layer may be formed from various expandable materials known to be useful for baffle and sealing applications. One example of a suitable expandable material is a heat-activated foam, such as the heat-activated foam sold by Sika Corporation of Madison Heights, Mich. under the name SIKABAFFLE® and described in the following U.S. Patents, all of which are incorporated herein by reference: U.S. Pat. Nos. 5,266,133; 5,373,027; 6,150,428; 6,368,438; and 6,387,470. Other expandable materials may also be used. The adhesive layer 130 may comprise any known adhesive suitable for securing a baffle in place prior to activation.

The grooves/channels 110 in FIGS. 3 and 4 permit activating heat applied to the baffle 100 to more quickly and effectively penetrate into the interior portion 107 of the expandable layer 105, which results in more effective and efficient expansion. Further, the inclusion of the grooves/channels 110—or any other types of voids in the expandable layer 105—results in less expandable material being used in the baffle 100. The reduction in expandable material makes the baffle less costly and lighter.

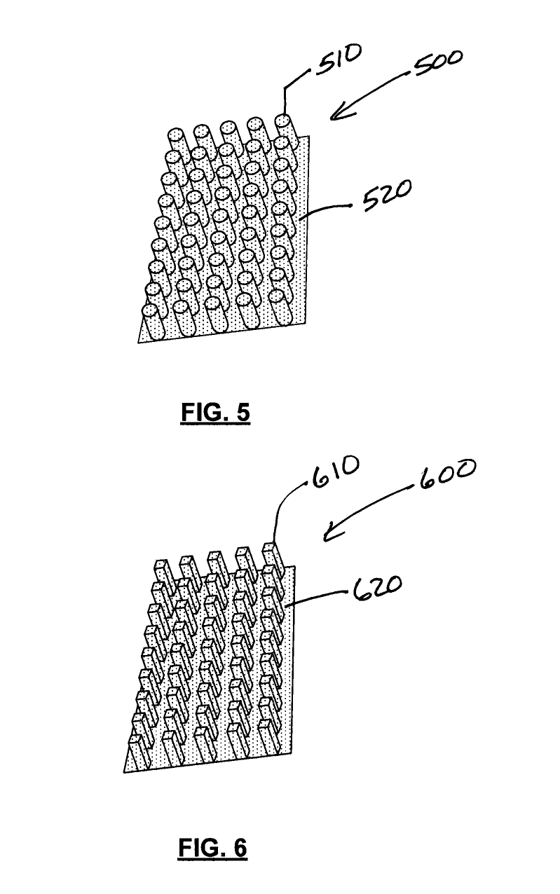

The two levels in the expandable layer 105 may be created with many different shapes and configurations other than the grooves/channels and ridges illustrated in FIGS. 3 and 4. FIG. 5 illustrates a baffle 500 wherein the projections and voids are created by a pattern of cylinders 510 (instead of ridges) that extend outward from the interior portion 520 of the expandable layer. FIG. 6 illustrates a baffle 600 wherein the projections and voids are created by a pattern of complementary squares 610 that extend outward from the interior portion 620 of the expandable layer. Various other shapes and configurations of the projections and voids may be employed to create two levels on the exterior surface of the expandable layer.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

What is claimed is:

1. A baffle, comprising:
an expandable layer coupled to an adhesive layer, together forming a generally planar baffle;
said expandable layer having an external surface;
said external surface having a pattern of projections and a pattern of voids relative to said projections, such that said projections define a first thickness of said expandable layer and said voids define a second thickness of said expandable layer, said first thickness being greater than said second thickness.

2. The baffle of claim 1, wherein said expandable layer expands in response to the application of heat.

3. The baffle of claim 1, wherein said pattern of projections comprises a plurality of ridges and said pattern of voids comprises a plurality of grooves separated by said ridges.

4. The baffle of claim 3, wherein said plurality of ridges are substantially parallel to each other.

5. The baffle of claim 3, wherein said plurality of ridges are substantially linear.

6. The baffle of claim 3, wherein said plurality of ridges are substantially non-linear.

7. The baffle of claim 1, wherein said pattern of projections comprises a plurality of cylinders extending outward from an interior portion of said expandable layer.

8. The baffle of claim 1, wherein said pattern of projections comprises a plurality of squares extending outward from an interior portion of said expandable layer.

9. The baffle of claim 1, wherein said expandable layer and said adhesive layer are extruded.

10. A baffle, comprising:
an expandable layer coupled to an adhesive layer, together forming a generally planar baffle;
said expandable layer having an external surface;
said external surface having a plurality of substantially parallel ridges and a plurality of substantially parallel grooves separated by said ridges, such that said ridges define a first thickness of said expandable layer and said voids define a second thickness of said expandable layer.

11. The baffle of claim 9, wherein said expandable layer expands in response to the application of heat.
